(19) United States
(12) Patent Application Publication
(10) Pub. No.: US 2013/0284494 A1
(43) Pub. Date: Oct. 31, 2013

(54) LIGHTWEIGHT COAXIAL CABLE

(71) Applicant: GENERAL CABLE TECHNOLOGIES CORPORATION, Highland Heights, KY (US)

(72) Inventor: Gary R. GEPPERT, Riverwoods, IL (US)

(73) Assignee: GENERAL CABLE TECHNOLOGIES CORPORATION, Highland Heights, KY (US)

(21) Appl. No.: 13/868,467

(22) Filed: Apr. 23, 2013

Related U.S. Application Data
(60) Provisional application No. 61/638,802, filed on Apr. 26, 2012.

(51) Int. Cl. H01B 11/18; H01B 7/02

(52) U.S. Cl. CPC H01B 11/1808; H01B 7/0275
USPC 174/115; 427/117

(57) ABSTRACT

A cable comprising at least one center conductor, an insulation layer surrounding the at least one center conductor, at least one substantially flat conductor running substantially parallel to the at least one center conductor and surrounding at least a portion of the insulation layer, and an outer jacket surrounding the at least one substantially flat conductor and the insulation layer, wherein no braid is disposed within the outer jacket, is provided. A method for making a cable is also provided.

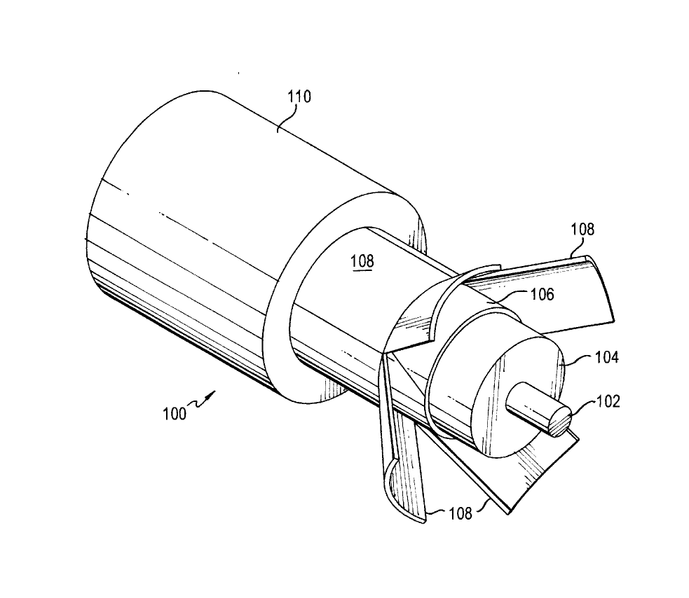

### RELATED APPLICATION

This application claims priority under 35 U.S.C. §119 to U.S. Provisional Application Ser. No. 61/638,802, filed Apr. 26, 2012, the disclosure of which is incorporated herein by reference in its entirety.

### FIELD OF THE INVENTION

The present invention relates to cable, such as coaxial data cable, that is lightweight. More specifically, the present invention relates to coaxial cable that replaces conventional braids with flat conductors to significantly reduce the size and weight of the cable.

### BACKGROUND OF THE INVENTION

Conventional coaxial cable includes multiple components, such as a copper conductor, an insulation layer, aluminum foil wrapped around the insulation layer, a copper or aluminum braid around the foil for providing shielding and strength to the cable, and an outer protective jacket. Standard coaxial cables often utilize an aluminum braid, a tinned braid, or a bare copper braid. Such conventional cabling is often heavy because each of the multiple components above contributes to the weight of the cable.

In addition to the added weight associated with the braid, the cost and effort associated with applying the braid to the cable may be high. Applying the braid to the cable is a time consuming process that requires specialized braiding machinery and additional human labor. Such braiding machinery is often expensive to purchase and maintain. Also, the cost of the braid material, such as copper, may be high, thus making the finished cable more expensive.

Because the cable is typically transported by trucks, the heavy weight of the cable significantly increases the expense of the transportation. In some scenarios, large quantities of braided cable are stored in small or confined spaces, where space and weight are at a premium. As a result, the larger and heavier reels of conventional cable require more space and/or trucks in order to transport, thus making the cable more expensive to use.

Therefore, a need exists for cable that is light in weight while maintaining optimal electrical and shielding properties.

### SUMMARY OF THE INVENTION

Accordingly, the present invention provides a cable having at least one center conductor, an insulation layer that surrounds the center conductor(s), at least one substantially flat conductor running substantially parallel to the center conductor(s) and surrounding at least a portion of the insulation layer, and an outer jacket that surrounds the substantially flat conductor(s) and the insulation layer, wherein no braid is disposed within the outer jacket.

In another embodiment, the present invention provides a cable having at least one center conductor, an insulation layer that surrounds the center conductor(s), a plurality of substantially flat conductors running substantially parallel to the center conductor(s) and substantially surrounding the insulation layer, and an outer jacket surrounding the plurality of substantially flat conductors, wherein no braid is disposed within the outer jacket.

The present invention also provides a method for making a cable, having the steps of providing at least one center conductor, extruding an insulation layer around the center conductor(s), providing at least one substantially flat conductor that runs substantially parallel to the center conductor(s) and surrounds at least a portion of the insulation layer, and extruding an outer jacket that surrounds the substantially flat conductor(s) and the insulation layer, wherein no braid is provided in the cable.

Other objects, advantages and salient features of the invention will become apparent from the following detailed description, which, taken in conjunction with the annexed drawing, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing FIGURE. The FIGURE is a perspective view of a cable according to an exemplary embodiment of the invention, showing each component of the cable.

### DETAILED DESCRIPTION OF THE INVENTION

Referring to the FIGURE, the present invention relates to a lightweight cable 100. The lightweight cable 100 may be a coaxial cable, for example. In general, the cable 100 includes a center conductor 102, an insulation layer 104 surrounding the center conductor 102, an optional shield layer 106 around the insulation layer 104, at least one substantially flat conductor 108 surrounding at least a portion of the insulation layer 104 and running longitudinally and generally parallel to the center conductor 102, and an outer protective jacket 110. No braid is provided or needed with the outer jacket 110 of the cable 100.

In a preferred embodiment, there are a plurality of substantially flat conductors 108 that substantially surround the insulation layer 104 and center conductor 102. Each substantially flat conductor 108 may be formed of aluminum or other lightweight material suitable for providing a return (ground) path in lieu of a conventional braid. The substantially flat conductors 108 are preferably made of aluminum. Unlike the braids of the prior art, the substantially flat conductors 108 are lighter while also providing conductivity for shielding. In one preferred embodiment, the substantially flat conductors 108 include four individual flat aluminum conductors that are configured to provide a return (i.e., ground) path running longitudinally and generally parallel to the center conductor 102. Each of the substantially flat conductors 108 may be equally spaced apart from each other or, alternately, may be asymmetrically spaced. The substantially flat conductors 108 may also either completely surround the shield 106 such that each of the substantially flat conductors 108 touches adjacent substantially flat conductors 108 or, alternately, the substantially flat conductors 108 may be configured such that there are gaps in between them such that no contact is made between the substantially flat conductors 108. In an alternative embodiment, the substantially flat conductors 108 are configured such that some make contact with the adjacent substantially flat conductors 108, while the remaining substantially flat conductors 108 have gaps in between them such that no contact is made.

In another alternative embodiment, the one or more substantially flat conductors 108 include two substantially flat conductors 108 which are located on opposite sides of the cable 100. However, it is appreciated that any number of substantially flat conductors 108 may be included in the cable 108 in place of a conventional braid for providing a lighter weight cable without departing from the scope of the subject matter described herein. Additionally, each of the substantially flat conductors 108 may be the same width or, alternately, the widths of the substantially flat conductors 108 may be different from one another. It is appreciated that the width of each substantially flat conductor 108 may vary or remain constant along the length of the cable 100 without departing from the scope of the subject matter described herein.

An advantage of the present invention is that because one less time-consuming step is required in order to produce the cable 100 (i.e., no braid application is necessary), the cable 100 may be produced faster and more efficiently. By utilizing the substantially flat conductors 108 according to the subject matter described herein, there is no need to purchase expensive braiders, the high cost of maintenance for braids is eliminated, and there is no need for labor to apply the braid. There is also no need to stock braiding materials and, therefore, space, labor, and time associated with maintaining inventory and ordering those braiding materials is saved. By making the cable 100 smaller and lighter, reel sizes which store large quantities of the cable 100 may be smaller and less space is required to store the finished cable 100. This may result in cost savings associated with transporting the finished cable 100.

The center conductor 102 is preferably formed of copper or aluminum with a copper cladding. An aluminum with copper cladding embodiment further reduces the weight of the cable 100 because aluminum is significantly lighter than copper, yet because the conductor 102 includes a copper cladding, optimum electrical properties are maintained.

The insulation layer 104 may be formed of any conventional insulation material, such as polyethylene, that is either foamed or solid. The shield 106 may include an aluminum foil layer. The outer jacket 110 may be formed of any conventional jacket material, such as PVC.

While particular embodiments have been chosen to illustrate the invention, it will be understood by those skilled in the art that various changes and modifications can be made therein without departing from the scope of the invention as defined in the appended claims. For example, although four substantially flat conductors are shown in the FIGURE, as described above, the present invention can include different numbers of substantially flat conductors or pairs of substantially flat conductors being separated or not separated in various combinations. Also, the same weight reduction concepts of the present invention can be applied to power cable.

What is claimed is:

1. A cable, comprising:
at least one center conductor;
an insulation layer surrounding said at least one center conductor;
at least one substantially flat conductor running substantially parallel to said at least one center conductor and surrounding at least a portion of said insulation layer; and
an outer jacket surrounding said at least one substantially flat conductor and said insulation layer,
wherein no braid is disposed within said outer jacket.

2. A cable according to claim 1, wherein
said at least one substantially flat conductor is formed of aluminum.

3. A cable according to claim 2, wherein
said at least one center conductor is formed of aluminum with copper cladding.

4. A cable according to claim 1, further comprising
at least two substantially flat conductors, each of said at least two substantially flat conductors being spaced generally equidistant from one another and substantially surrounding said insulation layer.

5. A cable according to claim 1, wherein
said insulation layer is formed of polyethylene.

6. A cable according to claim 1, further comprising
at least four substantially flat conductors, said four substantially flat conductors completely surrounding said insulation layer.

7. A cable, comprising:
at least one center conductor;
an insulation layer surrounding said at least one center conductor;
a plurality of substantially flat conductors running substantially parallel to said at least one center conductor and substantially surrounding said insulation layer; and
an outer jacket surrounding said plurality of substantially flat conductors,
wherein no braid is disposed within said outer jacket.

8. A cable according to claim 7, wherein
each of said substantially flat conductors is formed of aluminum.

9. A cable according to claim 8, wherein
said at least one center conductor is formed of aluminum with copper cladding.

10. A cable according to claim 9, wherein
said insulation layer is formed of polyethylene.

11. A cable according to claim 10, wherein
said outer jacket is formed of PVC.

12. A cable according to claim 7, wherein
said at least one center conductor is for either data or power.

13. A cable according to claim 7, wherein
said cable is a coaxial cable.

14. A cable according to claim 7, wherein
said plurality of substantially flat conductors include two substantially flat conductors that are spaced generally equidistant from one another.

15. A cable according to claim 7, wherein
said plurality of substantially flat conductors include four substantially flat conductors, said four substantially flat conductors completely surrounding said insulation layer.

16. A method for making a cable, comprising the steps of:
providing at least one center conductor;
extruding an insulation layer around the at least one center conductor;
providing at least one substantially flat conductor that runs substantially parallel to the at least one center conductor and surrounds at least a portion of the insulation layer; and
extruding an outer jacket that surrounds the at least one substantially flat conductor and the insulation layer,
wherein no braid is provided in the cable.

17. The method according to claim 16, wherein
the at least one substantially flat conductor is formed of aluminum.

18. The method according to claim 17, wherein
the at least one center conductor is formed of aluminum with copper cladding.

19. The method according to claim 16, wherein,
the step of providing at least one substantially flat conductor includes providing two substantially flat conductors and spacing the two substantially flat conductors generally equidistant from one another along the at least one center conductor.

20. The method according to claim 16, wherein
the step of providing at least one substantially flat conductor includes providing four substantially flat conductors that completely surround the insulation layer.
